(19) United States
(12) Patent Application Publication
(10) Pub. No.: US 2016/0306120 A1
(43) Pub. Date: Oct. 20, 2016

(54) PRODUCTION METHOD FOR OPTICAL DEVICES

(71) Applicant: FUJIKURA LTD., Tokyo (JP)

(72) Inventor: Ryokichi Matsumoto, Sakura-shi (JP)

(73) Assignee: FUJIKURA LTD., Tokyo (JP)

(21) Appl. No.: 15/192,335

(22) Filed: Jun. 24, 2016

Related U.S. Application Data
(63) Continuation of application No. PCT/JP2014/083933, filed on Dec. 22, 2014.

(30) Foreign Application Priority Data
Dec. 27, 2013 (JP) 2013-271123

(51) Int. Cl. G02B 6/36; G02B 6/30

(52) U.S. Cl. CPC G02B 6/3652; G02B 6/30

(57) ABSTRACT

A method includes: an optical component installation process P1 in which an optical component 23 is formed on one face of a component installation substrate 10 using a thin film process, the optical component 23 having an end portion 25 to be optically coupled to an optical fiber 40; an optical fiber fixing process P2 in which a V-shaped groove 35 is formed on one face of an optical fiber fixing substrate 30 and the optical fiber 40 is fixed to the V-shaped groove 35; and a contacting process P3 in which the surface of the component installation substrate 10 on which the optical component 23 is provided is contacted with the surface of the optical fiber fixing substrate 30 to which the optical fiber 40 is fixed.

### TECHNICAL FIELD

The present invention relates to a manufacturing method for an optical device, the method in which an optical device allowing a reduction in optical losses can be manufactured.

### BACKGROUND ART

For optical devices, an optical device is known in which an optical component, such as an optical waveguide or optical element, is installed on a substrate, the optical component is optically coupled to an optical fiber, and a light beam is entered from the optical fiber to the optical component, or a light beam from the optical component is emitted through the optical fiber.

Patent Literature 1 below describes such an optical device. The optical device described in Patent Literature 1 is fabricated in which an optical waveguide, which is an optical component, is formed on a Si substrate, a V-shaped groove is formed on the Si substrate, an optical fiber is installed on the V-shaped groove, and then the core of the optical fiber is optically coupled to the optical waveguide.
[Patent Literature 1] JP2771167 B2

### SUMMARY OF INVENTION

In the optical device described in Patent Literature 1, the position of the optical fiber is defined by the V-shaped groove formed on the substrate. In the optical component on the substrate, if a portion of the optical component, which has to be optically coupled to the optical fiber (e.g. the incident end of the optical waveguide), is displaced from the core of the optical fiber, this causes optical losses. Therefore, it is important to form the V-shaped groove at a correct position or in a correct depth.

This V-shaped groove is typically formed by etching, for example. After the optical component is installed on the substrate, the physical properties of the surface of the substrate are prone to be changed by oxidation, for example, through film deposition or etching, for example, in the process of forming the optical component. In the case in which the physical properties of the surface of the substrate are changed as described above, the changes of physical properties of the surface of the substrate are not uniformly, and often resulting in roughness on the surface of the substrate. The roughness on the surface of the substrate causes the difficulty of forming the V-shaped groove at a correct position and in a correct depth.

In this case, it becomes difficult to install the optical fiber at a correct position. This causes the difficulty of preventing optical losses due to light leakage from the connecting part of the optical component to the optical fiber.

Therefore, an object of the present invention is to provide a manufacturing method for an optical device, the method in which an optical device allowing a reduction in optical losses can be easily manufactured.

In order to solve the problem, a manufacturing method for an optical device according to the present invention is a method including: an optical component installation process in which an optical component is installed on one face of a component installation substrate using a thin film process, the optical component having an end portion to be optically coupled to an optical fiber; an optical fiber fixing process in which a V-shaped groove is formed on one face side of an optical fiber fixing substrate and the optical fiber is fixed to the V-shaped groove; and a contacting process in which a part of a surface of the component installation substrate on which the optical component is provided is contacted with at least a part of a surface of the optical fiber fixing substrate on which the optical fiber is fixed.

In the manufacturing method for an optical device, the substrate to which the optical fiber is fixed and the substrate on which the optical component is installed are separate substrates. On the substrate on which the optical component is installed, the optical component is installed through a thin film process. Thus, even in the case in which the face of the component installation substrate on which the optical component is installed is roughened because the physical properties are changed due to the influence of film deposition or etching, forming the V-shaped groove on the optical fiber fixing substrate is not affected. Consequently, the V-shaped groove can be formed on the optical fiber fixing substrate at a correct position or in a correct depth. Even in the state in which the surface of the component installation substrate is roughened after the optical component is installed as described above, the physical properties on the surface are only changed, and the roughened surface hardly affects the thickness of the component installation substrate. Therefore, the V-shaped groove is accurately formed on the optical fiber fixing substrate, and then the optical fiber fixing substrate to which the optical fiber is fixed is contacted with the component installation substrate on which the optical component is installed, allowing a reduction in the displacement of the end portion of the optical component from the end portion of the optical fiber in the direction perpendicular to a contact surface. Thus, in the direction perpendicular to the longitudinal direction of the optical fiber, alignment can be easily performed at least in the direction perpendicular to the contact surface. Accordingly, an optical device allowing a reduction in optical losses can be easily manufactured.

Even in the case in which a film is deposited or a film is etched on a portion of the component installation substrate on which the optical fiber fixing substrate has to be disposed for installing the optical component, the V-shaped groove is formed, taking into account of the thickness of the thin film or the etching thickness. Thus, the displacement of the end portion of the optical component from the end portion of the optical fiber in the direction perpendicular to the contact surface can be reduced. In other words, the surface of the component installation substrate on which the optical component is provided is the surface from which the component installation substrate is directly exposed prior to installing the optical component after the optical component has been installed, or the surface on which a thin film is stacked, or the etched surface after the optical component has been installed.

Preferably, on the component installation substrate, a guide is formed to control a motion of the optical fiber fixing substrate in a direction perpendicular to a longitudinal direction of the optical fiber, in a direction in parallel with the contact surface of the optical fiber fixing substrate with the component installation substrate.

The component installation substrate is contacted with the optical fiber fixing substrate for alignment in the direction perpendicular to the contact surface. The direction perpendicular to this contact surface is also the direction perpendicular to the longitudinal direction of the optical fiber. In addition to the alignment in the direction perpendicular to the contact surface, the guide further controls the motion of the optical fiber fixing substrate in the direction in parallel with the contact surface, in the direction perpendicular to the longitudinal direction of the optical fiber. Accordingly, alignment in two directions perpendicular to the longitudinal direction of the optical fiber can be performed. In the alignment in the two directions, it is demanded to perform alignment in accuracy stricter than the accuracy of alignment along the longitudinal direction of the optical fiber. Alignment in this strict accuracy is performed on the contact surface using the guide. Thus, an optical device allowing a reduction in optical losses can be more easily manufactured

Preferably, the guide does not control the motion of the optical fiber fixing substrate along the longitudinal direction of the optical fiber.

In this case, according to the position of the end portion of the optical fiber in the longitudinal direction, the optical fiber being fixed to the optical fiber fixing substrate, the optical fiber fixing substrate is adjusted along the longitudinal direction of the optical fiber. Thus, alignment in the longitudinal direction of the optical fiber can be performed.

Preferably, the guide is formed in a process of providing the optical component.

The optical component is formed together with the guide being formed. Thus, separate processes of providing the guide can be omitted. Commonly, in the case in which a component is formed with a thin film, the controllability of positions at which thin films are formed is significantly excellent. Thus, forming the guide with a thin film allows the guide to be formed at a more correct position. Consequently, an optical device allowing a further reduction in optical losses can be manufactured.

Alternatively, preferably, the component installation substrate is provided with an alignment mark. Based on the alignment mark, a relative positional relationship between the component installation substrate and the optical fiber fixing substrate is defined.

Based on the alignment mark, the relative positions in the direction in parallel with the contact surface of the component installation substrate with the optical fiber fixing substrate can be accurately set. Thus, the position of the optical fiber fixing substrate can be more easily determined to the component installation substrate.

Alternatively, preferably, both of the end portion of the optical component and the end portion of the optical fiber are visually recognizable. An alignment process is further provided in which after the contacting process, the end portion of the optical component and the end portion of the optical fiber are visually recognized, and relative positions in the direction perpendicular to the longitudinal direction of the optical fiber are adjusted in the direction in parallel with the contact surface of the component installation substrate with the optical fiber fixing substrate.

The end portion of the optical component and the end portion of the optical fiber are visually recognized, and the relative positions of the end portion of the optical component to the end portion of the optical fiber are adjusted. Thus, the positions can be accurately adjusted. The end portion of the optical component and the end portion of the optical fiber are visually recognizable. This also includes the case in which the end portion of the optical component and the end portion of the optical fiber are shot using a camera, for example, and the end portions are visually recognized through a monitor. The wavelength of a light beam for visually recognizing the end portion of the optical component and the end portion of the optical fiber is not limited to the wavelengths of visible light, which includes the wavelengths of invisible light, such as infrared rays.

In this case, the optical fiber may be fixed in the state in which the end portion of the optical fiber protrudes from the optical fiber fixing substrate. The end portion of the optical fiber is directly visually recognized. Thus, the position adjustment process can be more easily performed.

Alternatively, the optical fiber fixing substrate may be of optical transparency. The end portion of the optical fiber may be visually recognized through the optical fiber fixing substrate.

The optical fiber is visually recognized through the optical fiber fixing substrate. Thus, alignment can be performed without the end portion of the optical fiber protruding from the optical fiber fixing substrate. In other words, the optical fiber can be fixed in such a manner that the end portion of the optical fiber is located on the inner side of the edge of the optical fiber fixing substrate. Thus, in the processes, the possibility that the end portion of the optical fiber comes into contact with other positions and is then damaged can be decreased. For example, in the case in which the optical fiber fixing substrate is made of Si, the optical fiber fixing substrate transmits infrared rays. Thus, the end portion of the optical fiber can be visually recognized using infrared rays.

Alternatively, the end portion of the optical component may be visually recognizable. The optical fiber fixing substrate may be of optical transparency. An alignment process may be further provided, in which after the contacting process, the end portion of the optical component and the center line of the V-shaped groove are visually recognized, and relative positions are adjusted in the direction parallel with the contact surface of the component installation substrate with the optical fiber fixing substrate and perpendicular to the longitudinal direction of the optical fiber.

The axis of the optical fiber disposed on the V-shaped groove is matched with the center axis of the V-shaped groove. Typically, the center position of the V-shaped groove is located at the deepest position of the V-shaped groove. The center position is seen linearly through the optical fiber fixing substrate, thus, which is easily visually recognized. Therefore, the center axis of the optical fiber can be easily grasped, allowing easy alignment. In the case in which the center line of the V-shaped groove is visually recognized, this case also includes the case in which the center line of the V-shaped groove is shot using a camera, for example, and visually recognized through a monitor. The wavelength of a light beam for visual recognition is not limited to the wavelengths of visible light, which includes the wavelengths of invisible light, such as infrared rays.

When the component installation substrate is seen in a planar view, a groove is preferably formed at a position at which the optical fiber has to be disposed so that in contacting the component installation substrate with the optical fiber fixing substrate, the optical fiber does not touch the component installation substrate.

This groove is formed. Thus, the optical fiber is not buried in the inside of the V-shaped groove. Even in the case in which a part of the optical fiber is extruded from the V-shaped groove in the thickness direction of the optical fiber fixing substrate, the substrates can be appropriately contacted with each other.

In the optical fiber fixing process, a rotation direction of the optical fiber may be adjusted relative to the center axis of the optical fiber. In this case, preferably, the optical fiber is a polarization maintaining optical fiber or a multicore optical fiber.

This case is suited for the case of using an optical fiber that is necessary to align its axis in the rotation direction relative to the center axis, like a polarization maintaining optical fiber or a multicore optical fiber, which is an optical fiber whose rotation direction is adjusted. Preferably, the rotation direction of the optical fiber is adjusted prior to disposing the optical fiber on the V-shaped groove, because of easy adjustment. However, this adjustment may be performed after the optical fiber is disposed on the V-shaped groove. Alternatively, this adjustment may be performed in disposing the optical fiber on the V-shaped groove.

As described above, according to the present invention, there is provided a manufacturing method for an optical device, the method in which an optical device allowing a reduction in optical losses can be easily manufactured.

### BRIEF DESCRIPTION OF DRAWINGS

FIG. 1 is a plan view of an optical device according to an embodiment of the present invention.

FIG. 2 is a side view of the optical device illustrated in FIG. 1.

FIG. 3 is a cross sectional view of the optical device illustrated in FIGS. 1 and 2 taken along line V₁-V₁.

FIG. 4 is a cross sectional view of the optical device illustrated in FIGS. 1 and 2 taken along line V₂-V₂.

FIG. 5 is a flowchart of the process steps of a manufacturing method for an optical device.

FIG. 6 is a diagram in which a component installation substrate is being contacted with an optical fiber fixing substrate.

FIG. 7 is a diagram of a first alignment process and a second alignment process.

FIG. 8 is a diagram in which a component installation substrate is being contacted with an optical fiber fixing substrate according to a second embodiment.

FIG. 9 is a diagram of an alignment process according to the second embodiment.

FIG. 10 is a diagram in which a component installation substrate is being contacted with an optical fiber fixing substrate according to a third embodiment.

FIG. 11 is a diagram of an optical device according to a fourth embodiment similarly viewed as in FIG. 3.

FIG. 12 is a diagram of the optical device according to a fifth embodiment similarly viewed as in FIG. 3.

FIG. 13 is a diagram of an optical device according to the fifth embodiment similarly viewed as in FIG. 4.

### DESCRIPTION OF EMBODIMENTS

In the following, preferred embodiments of a manufacturing method for an optical device according to the present invention will be described in detail with reference to the drawings. For easy understanding, scales described in the drawings are sometimes different from scales described in the following description.

### First Embodiment

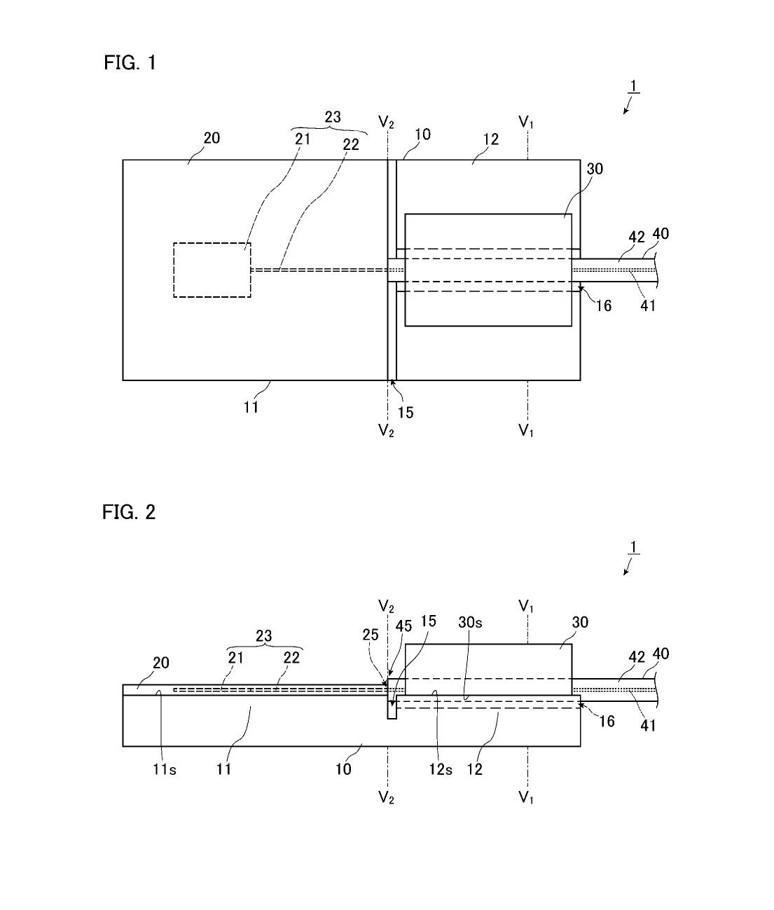

FIG. 1 is a diagram of an optical device according to an embodiment of the present invention, and FIG. 2 is a side view of the optical device illustrated in FIG. 1. FIG. is a cross sectional view of the optical device illustrated in FIGS. 1 and 2 taken along line V₁-V₁. FIG. 4 is a cross sectional view of the optical device illustrated in FIGS. 1 and 2 taken along line V₂-V₂.

As illustrated in FIGS. 1 and 2, an optical device 1 includes a component installation substrate 10, an optical layer 20 provided on the component installation substrate 10, an optical fiber fixing substrate 30 disposed on the component installation substrate 10, and an optical fiber 40 fixed to the optical fiber fixing substrate 30 as main configurations.

The component installation substrate 10 has a nearly rectangular shape in a planar view from one face side. On the one face side of the component installation substrate 10, a groove 15 is formed. One side relative to the groove 15 is an optical component installation area 11. The other side of the groove 15 is an optical fiber disposition area 12. A surface 11s of the optical component installation area 11 is flush with a surface 12s of the optical fiber disposition area 12, which are separated by the groove 15. On the optical fiber disposition area 12, a groove 16 is formed. The groove 16 extends in the direction orthogonal to the groove 15, and is formed shallower than the groove 15.

On the surface 11s on the optical component installation area 11, the optical layer 20 is provided. The optical layer 20 is formed of a plurality of thin films. Specifically, the optical layer 20 is configured of a lower layer formed on the surface 11s, an upper layer formed on the lower layer, and an optical element layer 21 and a waveguide 22 formed between the lower layer and the upper layer. However, in FIGS. 2 and 4 in which the lower layer and the upper layer can be visually recognized, the boundary between the lower layer and the upper layer is omitted. The lower layer and the upper layer are made of SiO2, for example. The optical element layer 21 is a layer that receives a light beam for a predetermined optical operation, which is a photodiode layer, for example. The waveguide 22 is made of Si. Thus, the waveguide 22 can guide a light beam at a predetermined wavelength based on the refractive index difference between the lower layer and the upper layer. For example, the waveguide 22 has a thickness of 0.5 μm, and has its width nearly equal to its thickness. The waveguide 22 can propagate a light beam at a wavelength of 1,550 nm in a single mode. The waveguide 22 is optically coupled to the optical element layer 21. A light beam is entered and propagated through the waveguide 22, and entered to the optical element layer 21. A light beam is emitted from the optical element layer 21, propagated through the waveguide 22, and then emitted from the waveguide 22. In the embodiment, an optical component 23 is configured of the optical element layer 21 and the waveguide 22. The waveguide 22 extends to the edge on the groove 15 side of the optical layer 20. An end portion 25 on the groove 15 side of the waveguide 22 is the end portion 25 that has to be optically coupled to the optical fiber 40. On the end portion 25, a mode field diameter converting portion is installed for matching the mode field diameter with the optical fiber 40 as necessary.

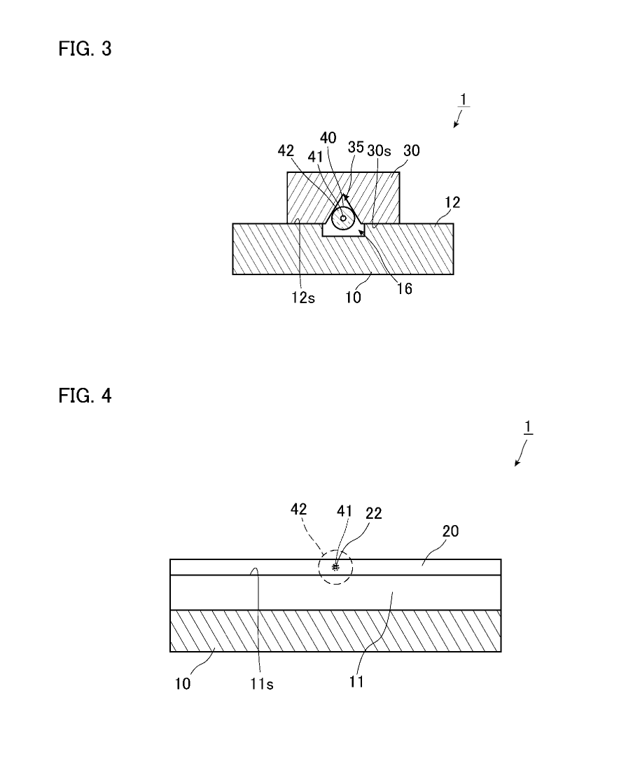

The optical fiber fixing substrate 30 has a size in which the optical fiber fixing substrate 30 can be disposed on the surface 12s of the optical fiber disposition area 12 of the component installation substrate 10. The optical fiber fixing substrate 30 is disposed on the surface 12s of the optical fiber disposition area 12 so as to cover at least a part of the groove 16 formed on the surface 12s side of the optical fiber disposition area 12. As illustrated in FIG. 3, on the optical fiber disposition area 12 side of the optical fiber fixing substrate 30, a V-shaped groove 35 is linearly formed. In the state in which the optical fiber fixing substrate 30 is disposed on the optical fiber disposition area 12, the V-shaped groove 35 is provided along the longitudinal direction of the groove 16, i.e. along the direction that is perpendicular to the longitudinal direction of the groove 15 formed on the component installation substrate 10. In other words, the optical fiber fixing substrate 30 is disposed on the optical fiber disposition area 12 in such a manner that the V-shaped groove 35 is directed in this direction. The surface 12s of the component installation substrate 10 is fixed to a surface 30s of the optical fiber fixing substrate 30 on the V-shaped groove side by fusion splicing or attachment. In fixing by attachment, contacting the surface 12s of the component installation substrate 10 with the surface 30s of the optical fiber fixing substrate 30 includes the case in which the surface 12s is touched and contacted with the surface 30s as well as the case in which the surface 12s is contacted with the surface 30s through an adhesive.

The optical fiber 40 includes a core 41 and a cladding that covers the outer circumferential surface of the core 41. This core 41 has a predetermined refractive index difference between the cladding 42, and has a predetermined diameter. Through the core 41, a light beam can be propagated in a single mode. At the wavelength of this light beam, the light beam is propagated through the waveguide 22 in a single mode. The optical fiber 40 is fixed to the V-shaped groove 35 along the longitudinal direction of the V-shaped groove 35 formed on the optical fiber fixing substrate 30. In the embodiment, the optical fiber 40 is fixed to the V-shaped groove 35 in such a manner that one end portion 45 of the optical fiber 40 protrudes from the optical fiber fixing substrate 30. As illustrated in FIG. 3, the optical fiber 40 is not buried in the inside of the V-shaped groove 35. The optical fiber is extruded from the V-shaped groove in the diameter direction. However, in the state in which the optical fiber fixing substrate 30 is disposed on the optical fiber disposition area 12 of the component installation substrate 10, a part of the optical fiber 40 is located in the inside of the groove 16, and the optical fiber 40 is not in contact with the component installation substrate 10. As illustrated in FIG. 4, the end portion 25 of the waveguide 22 is connected to the one end portion 45 of the optical fiber 40. The waveguide 22 is optically coupled to the core 41 of the optical fiber 40.

In the optical device 1 thus configured, in the case in which a light beam is propagated through the core 41 of the optical fiber 40 toward the waveguide 22, the light beam reaches the optical element layer 21 through the waveguide 22. On the other hand, in the case in which the optical element layer 21 emits a light beam to the waveguide 22, the light beam is propagated from the waveguide 22 to the optical fiber.

Next, a manufacturing method for the optical device 1 will be described.

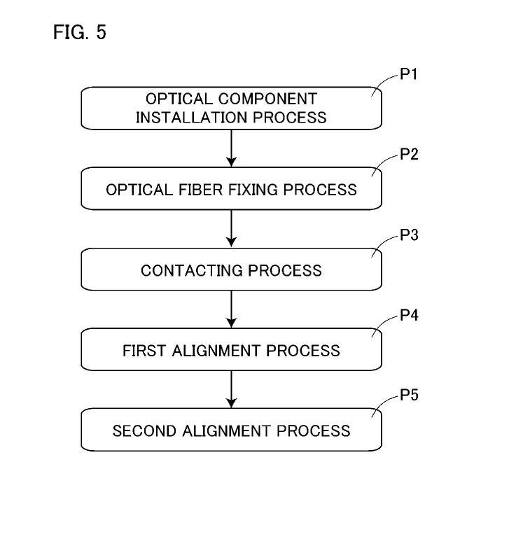

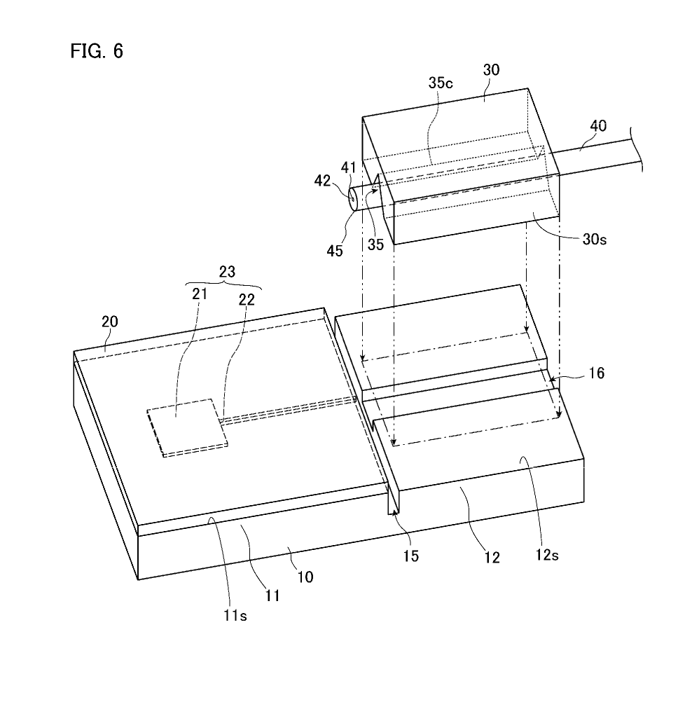

FIG. 5 is a flowchart of the process steps of a manufacturing method for the optical device 1. As illustrated in FIG. 5, the manufacturing method for the optical device 1 according to the embodiment includes an optical component installation process P1, an optical fiber fixing process P2, a contacting process P3, a first alignment process P4, and a second alignment process P5. FIG. 6 is a diagram in which the component installation substrate 10 on which the optical layer 20 is installed is being contacted with the optical fiber fixing substrate 30 to which the optical fiber 40 is fixed.

<Optical Component Installation Process P1>First, a substrate to be the component installation substrate 10 is prepared. In the embodiment, this substrate is a silicon substrate whose surface is oxidized. In other words, the substrate is mainly formed of Si, and its surface is a SiO₂ layer. The SiO₂ layer corresponds to the lower layer of the optical layer 20. The substrate is a flat-plate substrate. The grooves 15 and 16 are not formed on the substrate.

Subsequently, on the SiO₂ layer of the silicon substrate, the optical element layer 21 and the waveguide 22 formed of the Si layer are formed. The optical element layer 21 and the waveguide 22 are formed by a thin film process that is the combination of a film deposition processes, for example, chemical vapor deposition (CVD), vapor deposition, etc. and a removal process, for example etching process, in which unnecessary portions are removed. At this time, the waveguide 22 is formed in such a manner that the waveguide 22 extends to reach to the region on which the groove 15 should be formed. Subsequently, a SiO₂ film is deposited on a region to be the optical component installation area 11. The SiO₂ film is the upper layer of the optical layer 20. At this time, the SiO₂ film is deposited in such a manner that the upper layer is extruded to a region in which the groove 15 should be formed. In this manner, the optical element layer 21 and the waveguide 22 are sandwiched between the lower layer and the upper layer made of SiO₂. In this process, in the case in which a film is deposited on the optical fiber disposition area 12 or in the case in which the optical fiber disposition area 12 is etched, the surface 12s of the optical fiber disposition area 12 is the surface including the deposited film, or the etched surface.

In addition to the silicon substrate whose surface is oxidized, for the substrate which is to be the component installation substrate 10, an SOI (silicon on insulator) substrate can be used as well, which has a SiO₂ layer is inserted between a Si substrate and a Si layer, in surface, for example. In this case, the Si layer on the surface is etched to form the waveguide 22, and then the upper layer is formed similarly to the description above.

Subsequently, relative to a location at which the groove 15 should be formed, the groove 16 is formed by etching on the region on the opposite side of the region on which the optical layer 20 is formed. At this time, the groove 16 is formed so as to extend to reach to the region in which the groove 15 should be formed.

Subsequently, the groove 15 is formed. The groove 15 is formed by dicing, for example. As described above, the waveguide 22 extends to reach to the region in which the groove 15 should be formed. Thus, the waveguide 22 is exposed from the side surface of the optical layer 20 by dicing. The end portion including the portion from which the waveguide 22 is exposed is the end portion 25 that should be optically coupled to the core of the optical fiber 40. The groove 15 is formed deeper than the groove 16. As described above, the groove 16 is formed so as to extend to reach to the region in which the groove 15 should be formed, therefore the groove 16 is connected to the groove 15 at forming of the groove 15. After forming the groove 15, the optical layer 20 is deposited side area of groove 15 is the optical component installation area 11, the groove 16 formed side area of groove 15 is the optical fiber disposition area 12. In this manner, the grooves 15 and 16 are formed. Consequently, the component installation substrate 10 is formed from the prepared substrate. Note that, the groove 15 can be formed on the region in contact with the groove 16. The groove 15 does not necessarily have to be formed across from the one side surface of the component installation substrate 10 to the other side surface.

In the case in which the optical component 23 is installed using the thin film process including film deposition and etching as described above, the total of the thickness of a film deposition and etching for forming the end portion 25 of the optical component 23 that should be connected to the optical fiber, is preferably no more than 2.5 times the mode field diameter of a light beam propagated through the optical fiber 40. The reason is as follows. Commonly, the thickness of a thin film deposited through the film deposition process has errors within 10% with respect to the thickness of a thin film having a design value for deposition. Similarly, the thickness of a thin film to be removed through etching processes commonly has errors within 10% with respect to the thickness of a thin film having a design value for removal. Commonly, in the case in which the displacement of the axis of the core 41 of the optical fiber 40 at the end portion 45 from the axis of the end portion 25 of the optical component 23 is 25% or less of the mode field diameter of a light beam propagated through the optical fiber 40, an optical loss at the connecting part of the end portion 25 of the optical component 23 to the end portion 45 of the optical fiber 40 is one decibel or less. Thus, even in the case in which the position of the end portion 25 of the optical component 23 is displaced due to errors in the film thickness by film deposition or etching, the positional displacement of the end portion 25 of the optical component 23 from the end portion 45 of the optical fiber 40 is preferably 25% or less of the mode field diameter. Therefore, the above total of the thickness of the film deposition and etching for forming the end portion 25 of the optical component 23 is preferably 2.5 times or less of the mode field diameterbased on 0.25/0.10=2.5.

As illustrated in FIG. 6, through the thin film process described above, the optical component 23 formed of the optical element layer 21 and the waveguide 22 is installed on the component installation substrate 10. Note that, the forming method for the optical component 23 is an example. The optical component 23 may be formed on the component installation substrate 10 by other forming methods.

<Optical Fiber Fixing Process P2>

In this process, first, a substrate to be the optical fiber fixing substrate 30, to which the optical fiber 40 is fixed, and the optical fiber 40 are prepared. This substrate does not have the V-shaped groove 35 formed, and has a flat-plate shape. This substrate is a substrate made of Si, for example, through which a light beam at a specific wavelength is transmitted. In the case in which the cladding 42 of the optical fiber 40 is covered with a protective layer made of a resin, for example, its buffer layer is removed from the end portion 45 in a predetermined length.

Subsequently, the V-shaped groove 35 is formed on one face of the prepared substrate. Commonly, the V-shaped groove 35 is formed by etching processes. However, the V-shaped groove 35 may be formed by cutting. In disposing the optical fiber fixing substrate 30 on the component installation substrate 10 as described later, the V-shaped groove 35 is formed in such a manner that the axis of the core 41 of the optical fiber 40 is matched with the axis of the waveguide 22 in the direction perpendicular to the contact surface of the component installation substrate 10 with the optical fiber fixing substrate 30. Thus, in the optical component installation process P1, in the case in which a thin film is stacked on the optical fiber disposition area 12 of the component installation substrate 10 or in the case in which the optical fiber disposition area 12 is etched, the size of the V-shaped groove 35 is determined, taking into account of the thin film to be stacked or the amount of etching. In this manner, the V-shaped groove 35 is formed on the prepared substrate, and the substrate is the optical fiber fixing substrate 30.

Subsequently, the optical fiber 40 is disposed on the V-shaped groove 35, and the optical fiber 40 is fixed to the optical fiber fixing substrate 30. At this time, the optical fiber 40 is preferably disposed on the V-shaped groove in such a manner that the end portion 45 protrudes from the optical fiber fixing substrate 30. The optical fiber 40 is thus disposed, allowing the optical fiber 40 to be directly visually recognized in the stage in which the position of the optical fiber 40 is adjusted. The optical fiber 40 is fixed to the optical fiber fixing substrate 30 using an adhesive, for example.

This process and the optical component installation process P1 may be performed at the same time. Alternatively, the optical component installation process P1 may be performed after this process.

<Contacting Process P3>Next, the contacting process P3 is performed. As illustrated in FIG. 6, in this process, a part of the surface of the component installation substrate 10, on which the optical component 23 is provided, is contacted with at least a part of the surface of the optical fiber fixing substrate 30 to which the optical fiber 40 is fixed.

Specifically, the optical fiber fixing substrate 30 is disposed on the component installation substrate 10 in such a manner that the surface 12s of the optical fiber disposition area 12 of the component installation substrate 10 is contacted with the surface 30s of the optical fiber fixing substrate 30 to which the optical fiber 40 is fixed. At this time, even in the case in which a part of the optical fiber 40 is extruded from the V-shaped groove 35 in the direction perpendicular to the surface 30s, the extruded portion of the optical fiber 40 is accommodated in the inside of the groove 16 formed on the component installation substrate 10. Thus, the groove 16 prevents that the extruded portion of the optical fiber 40 obstructing the contact of the surface 12s of the optical fiber disposition area 12 with the surface 30s of the optical fiber fixing substrate 30.

As described above, the V-shaped groove 35 is formed in such a manner that the axis of the waveguide 22 is matched with the axis of the core 41 of the optical fiber 40 in the direction perpendicular to the contact surface of the component installation substrate 10 with the optical fiber fixing substrate 30. Thus, in this process, the alignment of the end portion 25 of the optical component 23 with the end portion 45 of the optical fiber 40 is completed in the direction perpendicular to the contact surface of the component installation substrate 10 with the optical fiber fixing substrate 30.

<First Alignment Process P4>

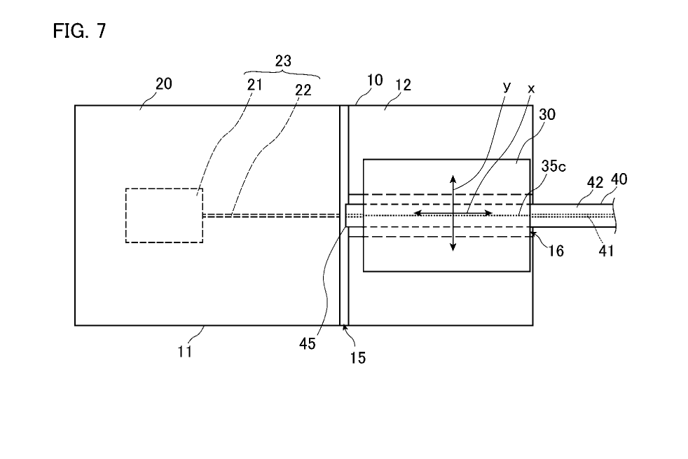

Next, the first alignment process is performed. FIG. 7 is a diagram of the first alignment process P4 and the second alignment process P5 according to the embodiment. In the first alignment process P4, the gap between the end portion 25 of the optical component 23 and the end portion 45 of the optical fiber 40 is adjusted by moving the optical fiber fixing substrate 30 along the longitudinal direction of the optical fiber 40. In other words, the optical fiber fixing substrate 30 is moved in the x-direction illustrated in FIG. 7. By this process, in the case in which it is desired to provide a zero gap between the end portion 25 of the optical component 23 and the end portion 45 of the optical fiber 40, for example, the optical fiber fixing substrate 30 is moved in the x-direction in such a manner that the end portion 45 of the optical fiber 40 comes into contact with the end portion 25 of the optical component 23. In the case in which a predetermined gap is provided between the end portion 25 of the optical component 23 and the end portion 45 of the optical fiber 40, the optical fiber fixing substrate 30 is moved in the x-direction in such a manner that this predetermined gap is provided between the end portion 25 of the optical component 23 and the end portion 45 of the optical fiber 40.

The optical fiber fixing substrate 30 is preferably moved while visually recognizing the end portion 45 of the optical fiber 40. At this time, preferably, the optical fiber 40 is shot using a camera, and the shot image is monitored to visually recognize the optical fiber 40.

As illustrated in the drawings in the embodiment, in the case in which the end portion 45 of the optical fiber 40 protrudes from the optical fiber fixing substrate 30, the optical fiber fixing substrate 30 is moved in the x-direction while directly visually recognizing the end portion 45 of the optical fiber 40. In the case of visual recognition using a camera as described above, the optical fiber 40 is directly shot by the camera for visual recognition.

On the other hand, unlike the drawings in the embodiment, in the case in which the end portion 45 of the optical fiber 40 does not protrude from the optical fiber fixing substrate 30 along the longitudinal direction of the optical fiber 40, the end portion 45 of the optical fiber 40 is visually recognized through the optical fiber fixing substrate 30. In this case, it is necessary that the optical fiber fixing substrate 30 be of optical transparency, through which at least a light beam at a predetermined wavelength is transmitted. When the optical fiber fixing substrate 30 is of optical transparency, the end portion 45 of the optical fiber 40 is visually recognized with a light beam at a wavelength at which the light beam is transmitted through the optical fiber fixing substrate 30. For example, in the case in which the optical fiber fixing substrate 30 is made of Si, the optical fiber 40 can be visually recognized using infrared rays.

Alternatively, this process may be performed without visually recognizing the end portion 45 of the optical fiber 40. For example, in the case in which the optical fiber fixing substrate 30 is moved in the x-direction in such a manner that the end portion 45 of the optical fiber comes into contact with the end portion 25 of the optical component 23 as described above, the end portion 45 of the optical fiber 40 is not necessarily visually recognized specifically. However, in order to reduce the damage to the optical fiber 40 in this alignment process, the end portion 45 of the optical fiber 40 is preferably visually recognized. Alternatively, in the case in which the optical component 23 is optically operable, the optical fiber fixing substrate 30 may be moved based on the measured result, in which a light beam is emitted from the optical fiber 40 to the optical component 23 for measuring an output from the optical component 23, or in which a light beam is emitted from the optical component 23 to the optical fiber 40 for measuring an output from the optical fiber 40. In the case in which the distance from the end portion 45 of the optical fiber 40 to the end face on the optical component 23 side of the optical fiber fixing substrate 30 is known, e.g. in the case in which the end portion 45 of the optical fiber 40 is located in the inside of the V-shaped groove 35 and the distance from the end portion 45 to the end face on the optical component 23 side of the optical fiber fixing substrate 30 is known, the position of the end portion 45 of the optical fiber 40 may be adjusted by adjusting the position of the optical fiber fixing substrate 30 in such a manner that a predetermined distance is provided between the end portion 25 of the optical component 23 and the end face of the optical fiber fixing substrate 30. In order to dispose the optical fiber 40 on the optical fiber fixing substrate 30 as described above, the optical fiber 40 may be disposed in the inside of the V-shaped groove 35 in the optical fiber fixing process P2 in such a manner that the distance from the end face of the optical fiber fixing substrate 30 to be the optical component 23 side to the end portion 45 of the optical fiber 40 is a predetermined distance.

Alternatively, the distance from the end face of the optical fiber fixing substrate 30 to be the optical component 23 side to the end portion 45 of the optical fiber 40 may be measured after the optical fiber 40 is disposed in the inside of the V-shaped groove 35.

Thus, alignment in the longitudinal direction of the optical fiber 40 is completed.

<Second Alignment Process P5>

Next, the second alignment process is performed. In the second alignment process P5, in the direction in parallel with the contact surface of the component installation substrate 10 with the optical fiber fixing substrate 30, the optical fiber fixing substrate 30 is moved along the direction perpendicular to the longitudinal direction of the optical fiber 40, and the relative positions of the component installation substrate 10 to the optical fiber fixing substrate 30 are adjusted. In other words, the optical fiber fixing substrate 30 is moved in the y-direction illustrated in FIG. 7. In this process, the end portion 25 of the optical component 23 is aligned with the end portion 45 of the optical fiber 40 in the direction perpendicular to the longitudinal direction of the optical fiber 40. Thus, the position of the optical fiber fixing substrate 30 in the y-direction is adjusted in such a manner that the axis of the end portion 25 of the optical component 23 is matched with the axis of the end portion 45 of the optical fiber 40.

The optical fiber fixing substrate 30 is preferably moved while visually recognizing the end portion 25 of the optical component 23 and the core 41 at the end portion 45 of the optical fiber 40. In this case, preferably, the end portion 25 of the optical component 23 and the core 41 at the end portion 45 of the optical fiber 40 are shot using a camera, and the shot image is monitored for visually recognizing the end portion 25 of the optical component 23 and the core 41 at the end portion 45 of the optical fiber 40.

In this process, as illustrated in the drawings in the embodiment, in the case in which the end portion 45 of the optical fiber 40 protrudes from the optical fiber fixing substrate 30, the core 41 at the end portion 45 of the optical fiber 40 is directly visually recognized, and the optical fiber fixing substrate 30 is moved in the y-direction. As described above, in the case of visual recognition using a camera, the optical fiber 40 is directly shot using a camera for visual recognition.

On the other hand, unlike the drawings in the embodiment, in the case in which the end portion 45 of the optical fiber 40 does not protrude from the optical fiber fixing substrate 30 along the longitudinal direction of the optical fiber 40, the core 41 at the end portion 45 of the optical fiber 40 is visually recognized through the optical fiber fixing substrate 30. Alternatively, in this case, a center line 35c of the V-shaped groove 35 may be visually recognized without visually recognizing the optical fiber 40. The reason is that in the case in which the optical fiber 40 is disposed on the V-shaped groove 35, the center line 35c of the V-shaped groove 35 is matched with the axis of the optical fiber 40 (the axis of the core 41) when viewed in the depth direction of the V-shaped groove 35. In the case in which the core 41 of the optical fiber 40 or the center line 35c of the V-shaped groove 35 is visually recognized through the optical fiber fixing substrate 30, it is necessary that the optical fiber fixing substrate 30 be of optical transparency in which at least a light beam at a predetermined wavelength is transmitted. When the optical fiber fixing substrate 30 is of optical transparency, the end portion 45 of the optical fiber 40 is visually recognized with a light beam at a wavelength at which the light beam is transmitted through the optical fiber fixing substrate 30. For example, in the case in which the optical fiber fixing substrate 30 is made of Si, the optical fiber 40 can be visually recognized using infrared rays.

For example, as illustrated in the drawings in the embodiment, in the case in which the end portion 25 of the optical component 23 is not exposed from the upper layer of the optical layer 20, the end portion 25 of the optical component 23 is visually recognized through the upper layer of the optical layer 20. In the case in which the end portion 25 is visually recognized through the upper layer of the optical layer 20, it is necessary that the upper layer be of optical transparency in which at least a light beam at a predetermined wavelength is transmitted. When the upper layer is of optical transparency, the end portion 25 of the optical component 23 is visually recognized using a light beam at a wavelength at which the light beam is transmitted through the upper layer. For example, in the case in which the upper layer of the optical layer 20 is made of Si as described above, the end portion 25 of the optical component 23 can be visually recognized using infrared rays. In this case, when the optical fiber fixing substrate 30 is made of Si as described above, the core 41 of the optical fiber 40, the center line 35c of the V-shaped groove 35 of the optical fiber fixing substrate 30, and the end portion 25 of the optical component 23 can be visually recognized at the same time using infrared rays. On the other hand, unlike the drawings in the embodiment, in the case in which the end portion 25 of the optical component 23 is exposed, the end portion 25 of the optical component 23 is directly visually recognized.

This process may be performed without visually recognizing the end portion 25 of the optical component 23. For example, in the case in which the optical component 23 is optically operable, the optical fiber fixing substrate 30 can be moved in the y-direction based on the measured result, in which a light beam is emitted from the optical fiber 40 to the optical component 23 for measuring an output from the optical component 23, or in which a light beam is emitted from the optical component 23 to the optical fiber 40 for measuring an output from the optical fiber 40.

Thus, in the direction in parallel with the contact surface of the component installation substrate 10 with the optical fiber fixing substrate 30, alignment in the direction perpendicular to the longitudinal direction of the optical fiber 40 is completed. Note that, this process and the first alignment process P4 may be performed at the same time. Alternatively, the first alignment process P4 may be performed after this process.

Subsequently, the component installation substrate 10 is fixed to the optical fiber fixing substrate 30. The component installation substrate 10 is fixed to the optical fiber fixing substrate 30 by fusion splicing or adhension. Fusion splicing is performed by laser fusion splicing or ultrasonic bonding, for example. For example, adhension may be performed as below. An adhesive is coated on the surface 30s of the optical fiber fixing substrate 30 in advance, and the adhesive is then hardened. Alternatively, after the completion of the alignment process, an adhesive is coated over the edge of the surface 30s of the optical fiber fixing substrate 30 and the surface 12s of the optical fiber disposition area 12 of the component installation substrate 10, and then the adhesive is hardened.

Thus, the optical device 1 illustrated in FIGS. 1 to 4 is obtained.

As described above, in accordance with the manufacturing method for the optical device 1 according to the embodiment, the optical fiber fixing substrate 30, to which the optical fiber 40 is fixed, and the component installation substrate 10, on which the optical component 23 is installed, are separate substrates. On the component installation substrate 10, the optical component 23 is installed through the thin film process. Thus, even in the case in which the surface 12s of the optical fiber disposition area 12 of the component installation substrate 10 is roughened and the physical properties are changed due to the influence of etching, forming the V-shaped groove 35 on the optical fiber fixing substrate 30 is not affected. Therefore, the V-shaped groove 35 can be formed at a correct position or in a correct size on the optical fiber fixing substrate 30. Even in the state in which the surface 12s of the optical fiber disposition area 12 is roughened after the optical component 23 is installed, the physical properties on the surface are only changed, hardly affecting the thickness of the component installation substrate 10. Thus, the V-shaped groove 35 is accurately formed on the optical fiber fixing substrate 30, and the optical fiber fixing substrate 30 to which the optical fiber 40 is fixed is contacted with the component installation substrate 10. Consequently, the displacement of the end portion 25 of the optical component 23 from the end portion 45 of the optical fiber 40 in the direction perpendicular to the contact surface can be reduced, and the alignment of the optical fiber 40 is completed in the direction perpendicular to the contact surface of each of the substrates. As described above, in the alignment direction of the position of the optical fiber 40, alignment can be easily performed at least in the direction perpendicular to the contact surface. Accordingly, an optical device 1 allowing a reduction in optical losses can be easily manufactured.

### Second Embodiment

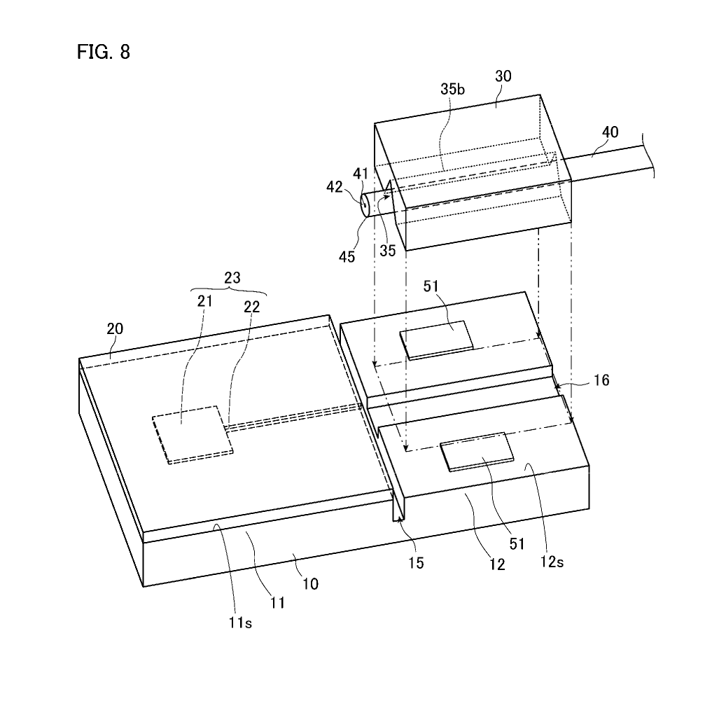

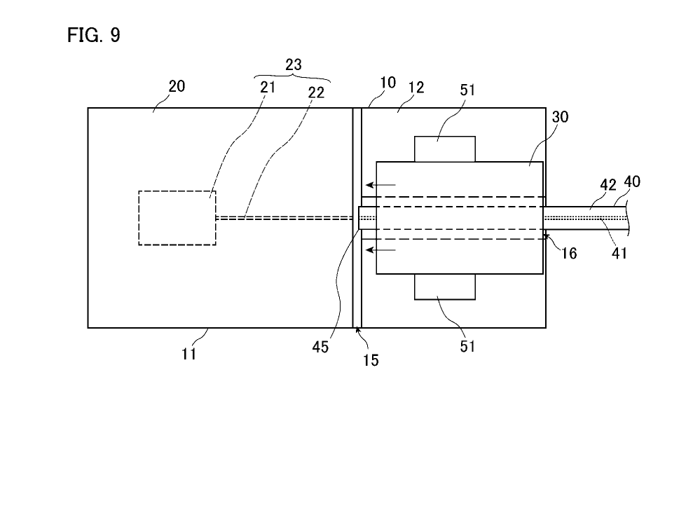

Next, referring to FIGS. 8 and 9, a second embodiment of the present invention will be described in detail. Components the same as or equivalent to ones in the first embodiment are designated the same reference numerals and signs, and the overlapping description is omitted unless otherwise specified.

FIG. 8 is a diagram in which the component installation substrate 10 is being contacted with the optical fiber fixing substrate 30 in the embodiment. As illustrated in FIG. 8, the component installation substrate according to the embodiment is different from the component installation substrate 10 according to the first embodiment in that a pair of guides 51 is provided on the surface 12s of the optical fiber disposition area 12. In disposing the optical fiber fixing substrate 30 on the component installation substrate 10, these guides 51 control the motion of the optical fiber fixing substrate 30 in the direction perpendicular to the longitudinal direction of the optical fiber 40 (in the y-direction in FIG. 7), in the direction in parallel with the contact surface of the optical fiber fixing substrate 30 with the component installation substrate 10, and the guides 51 do not control the motion of the optical fiber fixing substrate 30 in the direction along the longitudinal direction of the optical fiber 40 (illustrated in FIG. 7 in the x-direction).

The guides 51 are spaced with a gap the same as the width of the optical fiber fixing substrate 30 in the direction perpendicular to the longitudinal direction of the optical fiber 40. Therefore, the pair of guides 51 controls the motion of the optical fiber fixing substrate 30 by sandwiching the opposite side surfaces of the optical fiber fixing substrate 30 on the component installation substrate 10. Thus, in disposing the optical fiber fixing substrate 30 on the component installation substrate 10, the pair of guides 51 is provided at locations in such a manner that the optical fiber fixing substrate 30 is located as the axis of the end portion 25 of the optical component 23 is matched with the axis of the end portion 45 of the optical fiber 40.

In order to provide these guides 51, the guides can be formed in the optical component installation process P1 in the first embodiment. The guides 51 are preferably formed together with the optical component 23 in the thin film process of forming the optical component 23. Commonly, the controllability of positions at which thin films are formed is significantly excellent. Thus, forming the guides 51 with a thin film allows the guides 51 to be formed at more correct positions. Specifically, forming the guides 51 together with the optical component 23 allows using the same mask which contains patterns of the optical component and the guides 51. Consequently, the positional correlation of the optical component 23 with the guides 51 can be appropriately controlled.

The optical fiber fixing process P2 is then performed similarly to the first embodiment.

Subsequently, the contacting process P3 is performed similarly to the first embodiment. However, in the embodiment, the optical fiber fixing substrate 30 is disposed on the component installation substrate 10 in such a manner that the optical fiber fixing substrate 30 is sandwiched between the guides 51.

FIG. 8 is a diagram of an alignment process according to the embodiment. In the first embodiment, the first alignment process P4 and the second alignment process P5 are performed. However, in the embodiment, the guides 51 are formed at correct positions. Thus, the second alignment process is unnecessary. Therefore, as illustrated in FIG. 8, the alignment process is performed by moving the optical fiber fixing substrate 30 along the longitudinal direction of the optical fiber 40. The specific method of the alignment process is similar to the first alignment process P4 in the first embodiment.

Subsequently, the optical fiber fixing substrate 30 is fixed to the component installation substrate 10 similarly to the first embodiment. Thus, the optical device according to the embodiment is obtained.

In accordance with the manufacturing method for an optical device according to the embodiment, the optical fiber fixing substrate 30 is disposed on the component installation substrate 10, and this performs alignment of the direction perpendicular to the longitudinal direction of the optical fiber, in the direction in parallel with the contact surface of the component installation substrate 10 with the optical fiber fixing substrate 30. Therefore, in accordance with the manufacturing method for an optical device according to the embodiment, disposing of the optical fiber fixing substrate 30 on the component installation substrate 10, performs alignment in two directions perpendicular to the longitudinal direction of the optical fiber. Consequently, in accordance with the manufacturing method for an optical device according to the embodiment, an optical device allowing a reduction in optical losses can be manufactured easier than in the manufacturing method for an optical device according to the first embodiment.

In the embodiment, the guides 51 are installed at locations at which the opposite side surfaces of the optical fiber fixing substrate 30 are sandwiched. However, the locations of the guides 51 are not limited to these locations. For example, a configuration may be possible in which uniform grooves are formed on the surface 30s of the optical fiber fixing substrate 30, the grooves extending in the direction in parallel with the longitudinal direction of the optical fiber 40, and guides in shapes and at locations fit into the grooves are provided on the surface 12s of the optical fiber disposition area 12.

The guides 51 may be provided so as to control the motion of the optical fiber fixing substrate 30 in the direction along the longitudinal direction of the optical fiber 40.

The guides 51 may be provided by a thin film process different from the optical component installation process P1. The guides 51 may be formed of different members as the guides 51 are not formed of thin films.

### Third Embodiment

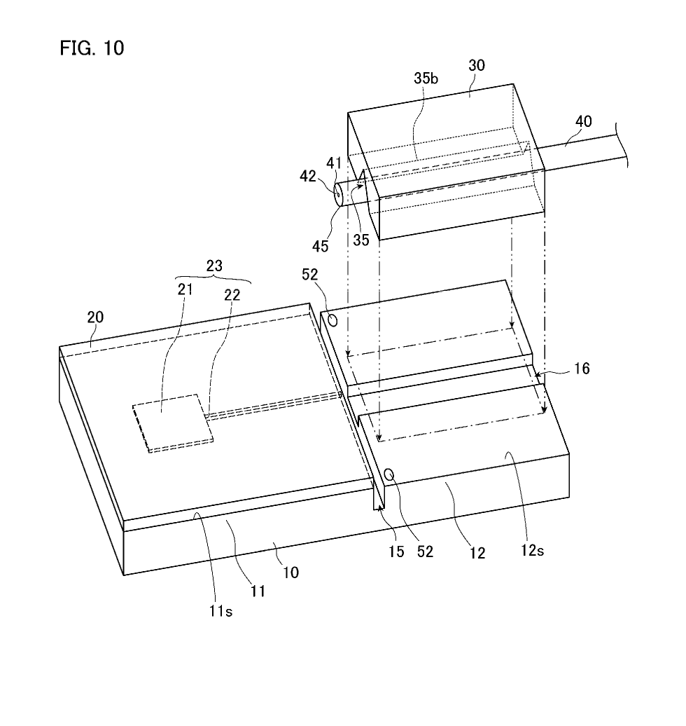

Next, referring to FIG. 10, a third embodiment of the present invention will be described in detail. Components the same as or equivalent to ones in the first embodiment are designated the same reference numerals and signs, and the overlapping description is omitted unless otherwise specified.

FIG. 10 is a diagram in which the component installation substrate 10 is being contacted with the optical fiber fixing substrate 30 in the embodiment. As illustrated in FIG. 10, the component installation substrate 10 according to the embodiment is different from the component installation substrate 10 according to the first embodiment in that a pair of alignment marks 52 is provided on the surface 12s of the optical fiber disposition area 12.

The alignment marks 52 are preferably provided in advance on a substrate to be the component installation substrate 10. Relative to the positions of the alignment marks, the optical component installation process P1 is performed similarly to the first embodiment. Thus, the positional relationship between the alignment marks 52 and the end portion 25 of the optical component 23 can be grasped.

The optical fiber fixing process P2 is then performed similarly to the first embodiment.

Subsequently, the contacting process P3 is performed. In the contacting process in the embodiment, the position of the optical fiber fixing substrate 30 is determined based on the alignment marks 52, and the optical fiber fixing substrate 30 is disposed on the component installation substrate 10. In the case in which the relationship between the positions of the alignment marks 52 and the position of the end portion 25 of the optical component 23 can be grasped as described above, the optical fiber fixing substrate 30 can be disposed at an appropriate position. Thus, the first alignment process P4 and the second alignment process P5 of the first embodiment can be omitted. However, in the case in which the position of the end portion 45 of the optical fiber 40 in the optical fiber fixing substrate 30 has variability in the optical fiber fixing process P2, the first alignment process P4 is preferably performed.

Subsequently, the optical fiber fixing substrate 30 is fixed to the component installation substrate 10 similarly to the first embodiment. Thus, the optical device according to the embodiment is obtained.

### Fourth Embodiment

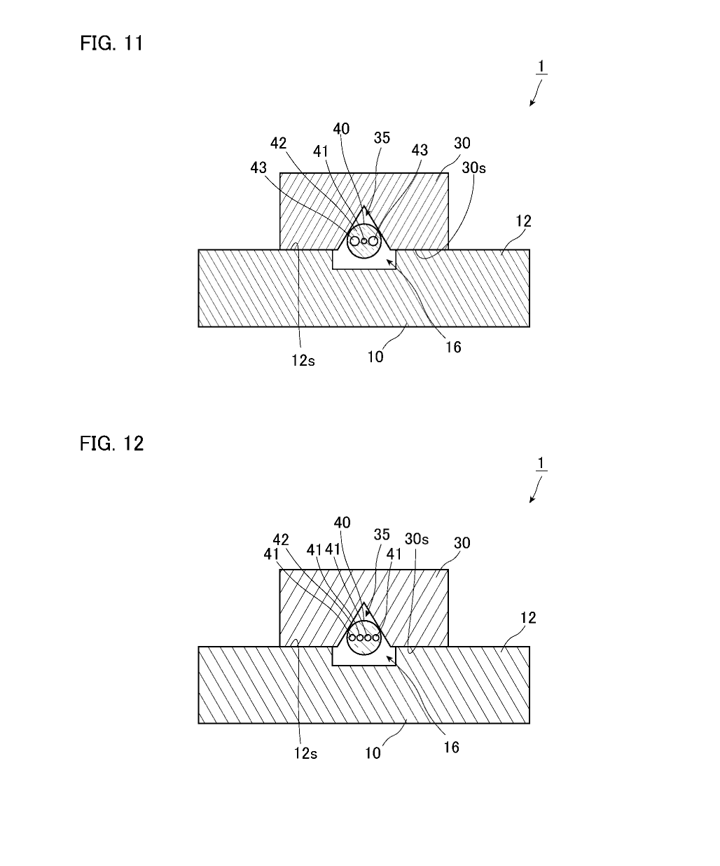

Next, referring to FIG. 11, a fourth embodiment of the present invention will be described in detail. Components the same as or equivalent to ones in the first embodiment are designated the same reference numerals and signs, and the overlapping description is omitted unless otherwise specified.

FIG. 11 is a diagram of an optical device according to the embodiment similarly viewed as in FIG. 3. As illustrated in FIG. 11, the optical device 1 according to the embodiment is different from the optical device 1 according to the first embodiment in that the optical fiber 40 has a pair of stress applying parts 43 sandwiching the core 41. In other words, the optical fiber 40 according to the embodiment is a polarization maintaining and absorption reducing fiber (PANDA fiber), which is one kind of polarization maintaining optical fibers. The stress applying parts 43 are portions to apply stress to the core in manufacturing the optical fiber 40. The stress applying parts 43 have a diameter greater than the diameter of the core, for example, and are provided at locations a certain distance apart from the core 41. These stress applying parts 43 are provided. Thus, the optical fiber 40 can propagate a single-polarization light beam as the polarization axis is maintained. Therefore, a light beam entered to this optical fiber 40 is sometimes converted into a single-polarization light beam whose polarization axis is matched with the direction of the stress applying parts of the polarization maintaining optical fiber or whose polarization axis is orthogonal to the direction of the stress applying parts. Thus, in order to match the polarization direction of a light beam emitted from the waveguide 22 and entered to the optical fiber 40, or emitted from the optical fiber 40 and entered to the waveguide 22, it is important to adjust the position of the optical fiber 40 in the rotation axis direction.

In a manufacturing method for the optical device 1 according to the embodiment, the optical component installation process P1 is performed similarly to the first embodiment. In the optical fiber fixing process P2 of the embodiment, the rotation direction of the optical fiber 40 is adjusted relative to the center axis of the optical fiber 40 in such a manner that a desired direction is provided for the polarization direction of a light beam emitted from the waveguide 22 and entered to the optical fiber 40, or emitted from the optical fiber 40 and entered to the waveguide 22. This adjustment is performed while visually recognizing the end portion 45 of the optical fiber 40, for example. For example, the end portion 45 of the optical fiber 40 can be visually recognized by shooting the end portion 45 using a camera, for example, through a monitor. The rotation direction of the optical fiber 40 is preferably adjusted prior to disposing the optical fiber 40 on the V-shaped groove 35. The reason is that the adjustment is easily performed by visually recognizing the optical fiber 40. However, the adjustment may be performed after the optical fiber 40 is disposed on the V-shaped groove 35. Alternatively, the adjustment may be performed in disposing the optical fiber 40 on the V-shaped groove 35.

Subsequently, the contacting process P3, the first alignment process P4, and the second alignment process P5 are performed similarly to the first embodiment. Thus, the optical device according to the embodiment is obtained.

### Fifth Embodiment

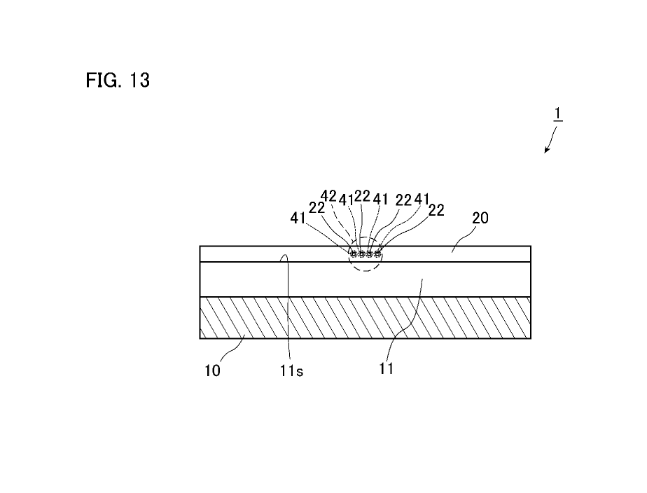

Next, referring to FIGS. 12 and 13, a fifth embodiment of the present invention will be described in detail. Components the same as or equivalent to ones in the first embodiment are designated the same reference numerals and signs, and the overlapping description is omitted unless otherwise specified.

FIG. 12 is a diagram of an optical device according to the embodiment similarly viewed as in FIG. 3. FIG. 13 is a diagram of the optical device according to the embodiment similarly viewed as in FIG. 4. As illustrated in FIG. 12, the optical device 1 according to the embodiment is a multicore optical fiber in which the optical fiber 40 includes a plurality of cores 41. As illustrated in FIG. 13, the optical device 1 according to the embodiment is different from the optical device 1 according to the first embodiment in that a plurality of waveguides 22 is formed on the optical layer 20 on the component installation substrate 10. In the optical fiber 40 according to the embodiment, the plurality of cores 41 is linearly arranged. Thus, the number of the plurality of waveguides 22 formed on the optical layer 20 on the component installation substrate 10 is the same as the number of the plurality of cores 41 of the optical fiber 40, and the plurality of waveguides 22 is spaced with the same gap. In this optical device 1, it is important that light beams emitted from the waveguides 22 be individually entered to the cores 41 of the optical fiber 40, or light beams emitted from the cores 41 of the optical fiber 40 be individually entered to the waveguides 22.

The optical component installation process P1 in a manufacturing method for the optical device 1 according to the embodiment is different from the optical component installation process P1 in the first embodiment in that the plurality of waveguides 22 is formed. In this process of the embodiment, the waveguides 22 are formed in such a manner that the number of the gaps of the plurality of waveguides 22 is the same as the number of the plurality of cores 41 of the optical fiber 40 spaced with the same gap as described above.

In the optical fiber fixing process P2 of the embodiment, after the contacting process P3 is performed, the rotation direction of the optical fiber 40 is adjusted relative to the center axis of the optical fiber 40 in such a manner that the array direction of the plurality of cores of the optical fiber 40 is the same as the array direction of the plurality of waveguides 22 of the optical layer 20. This adjustment can be performed similarly to the adjustment in the fourth embodiment. Also in the embodiment, adjustment in the rotation direction of the optical fiber 40 is preferably performed prior to disposing the optical fiber 40 on the V-shaped groove 35. However, the adjustment may be performed after the optical fiber 40 is disposed on the V-shaped groove 35. Alternatively, the adjustment may be performed in disposing the optical fiber 40 on the V-shaped groove 35.

Subsequently, the contacting process P3, the first alignment process P4, and the second alignment process P5 are performed similarly to the first embodiment. Thus, the optical device according to the embodiment is obtained.

As described above, the present invention is described as the first to the fifth embodiments are taken as examples. However, the present invention is not limited to these embodiments.

For example, in the foregoing embodiments, the optical component 23 includes the optical element layer 21 and the waveguide 22. However, the present invention is not limited to this configuration. For example, the optical component may include only the waveguide. Alternatively, the optical component may include only an optical element layer having an end portion through which at least a light beam is entered or emitted.

As described above, in accordance with a manufacturing method for an optical device according to the present invention, an optical device allowing a reduction in optical losses can be easily manufactured, which can be used in the fields of optical communication devices, optical measurement devices, and other devices.

1. A manufacturing method for an optical device, the method comprising:
an optical component installation process in which an optical component is installed on one face of a component installation substrate using a thin film process, the optical component having an end portion to be optically coupled to an optical fiber;
a process in which a groove is formed at a position at which the optical fiber has to be disposed when the component installation substrate is seen in a planar view;
a process in which a groove is formed, the groove crossing the groove formed at the position at which the optical fiber has to be disposed on the component installation substrate, the groove being deeper than the groove formed at the position at which the optical fiber has to be disposed, the end portion of the optical component being exposed from the groove crossing the groove formed at the position at which the optical fiber has to be disposed;
an optical fiber fixing process in which a V-shaped groove is formed on one face side of an optical fiber fixing substrate and the optical fiber is fixed to the V-shaped groove; and
a contacting process in which a part of a surface of the component installation substrate on which the optical component is provided is contacted with at least a part of a surface of the optical fiber fixing substrate on which the optical fiber is fixed, wherein
the groove formed at the position at which the optical fiber has to be disposed on the component installation substrate has a size in which in contacting the component installation substrate with the optical fiber fixing substrate, the optical fiber is not contacted with the component installation substrate.

2. The manufacturing method for an optical device according to claim 1, wherein
on the component installation substrate, a guide is formed to control a motion of the optical fiber fixing substrate in a direction perpendicular to a longitudinal direction of the optical fiber, in a direction in parallel with a contact surface of the optical fiber fixing substrate with the component installation substrate.

3. The manufacturing method for an optical device according to claim 2, wherein
the guide does not control the motion of the optical fiber fixing substrate along the longitudinal direction of the optical fiber.

4. The manufacturing method for an optical device according to claim 2, wherein
the guide is formed in a process of providing the optical component.

5. The manufacturing method for an optical device according to claim 1, wherein:
the component installation substrate is provided with an alignment mark; and
based on the alignment mark, a relative positional relationship between the component installation substrate and the optical fiber fixing substrate is defined.

6. The manufacturing method for an optical device according to claim 1, wherein:
both of the end portion of the optical component and the end portion of the optical fiber are visually recognizable; and
an alignment process is further provided in which after the contacting process, the end portion of the optical component and the end portion of the optical fiber are visually recognized, and relative positions in the direction perpendicular to the longitudinal direction of the optical fiber are adjusted in the direction in parallel with the contact surface of the component installation substrate with the optical fiber fixing substrate.

7. The manufacturing method for an optical device according to claim 6, wherein
the optical fiber is fixed in a state in which the end portion of the optical fiber protrudes from the optical fiber fixing substrate

8. The manufacturing method for an optical device according to claim 6, wherein:
the optical fiber fixing substrate is of optical transparency; and
the end portion of the optical fiber is visually recognized through the optical fiber fixing substrate.

9. The manufacturing method for an optical device according to claim 1, wherein:
the end portion of the optical component is visually recognizable;
the optical fiber fixing substrate is of optical transparency; and
an alignment process is further provided in which after the contacting process, the end portion of the optical component and the center line of the V-shaped groove are visually recognized, and relative positions are adjusted in the direction parallel with the contact surface of the component installation substrate with the optical fiber fixing substrate and perpendicular to the longitudinal direction of the optical fiber.

10. The manufacturing method for an optical device according to claim 1, wherein
in the optical fiber fixing process, a rotation direction of the optical fiber is adjusted relative to the center axis of the optical fiber.

11. The manufacturing method for an optical device according to claim 1, wherein
the optical fiber is a polarization maintaining optical fiber or a multicore optical fiber.
